(19) United States
(12) Patent Application Publication
(10) Pub. No.: US 2014/0301331 A1
(43) Pub. Date: Oct. 9, 2014

(54) Selecting a Transport Format for Transmission of Data Blocks Between a Base Station and a Mobile Terminal

(71) Applicant: Jaroslaw Niewczas, Jozefow (PL)

(72) Inventor: Jaroslaw Niewczas, Jozefow (PL)

(73) Assignee: Telefonaktiebolaget L M Ericsson (publ), Stockholm (SE)

(21) Appl. No.: 14/353,333

(22) PCT Filed: Oct. 24, 2011
(86) PCT No.: PCT/SE2011/051255

§ 371 Date: Apr. 22, 2014

(51) Int. Cl. H04W 28/04; H04W 64/00

(52) U.S. Cl. CPC H04W 28/04; H04W 64/006
USPC 370/329

(57) ABSTRACT

A method of selecting a transport format (11) for transmission of data blocks between a base station and a mobile terminal in a wireless telecommunications system, wherein the mobile terminal is capable of moving at a speed relative to the base station, comprises determining (101) transport formats (11) possible for transmission of data blocks from the device (1); and determining (102) for each possible transport format a set of quality metrics (12). The method further comprises determining (103) for each possible transport format modified sets of quality metrics (13, 14, 15, 18) in dependence of speed and code rate for different speeds; estimating (104) the speed of the mobile terminal, and selecting (105) one of said possible transport formats (11) for transmission of a data block in dependence of said estimated speed and said modified sets of quality metrics (13, 14, 15, 16). This provides a method of selecting a transport format (11) with improved performance in high speed conditions.

### TECHNICAL FIELD

The disclosure relates to a method a device, a computer program and a computer readable medium for selecting a transport format for transmission of data blocks between a base station and a mobile terminal in a wireless telecommunications system, wherein the mobile terminal is capable of moving at a speed relative to the base station.

### BACKGROUND

When data blocks are transmitted between a base station and a mobile terminal in a wireless telecommunications system a transport format is associated with each data block. The transport format specifies how the data block is to be transmitted over the radio interface by including information about e.g. block size and modulation scheme. From the transport format a resulting code rate can be derived. The code rate is the proportion of a data stream that is useful, i.e. non-redundant. The transport format can be varied between consecutive transmission time intervals. By varying the transport format, the block size and/or the number of data blocks, different data rates can thus be realized.

Base station downlink transport-format scheduling algorithms are typically designed to achieve best cell throughput performance, while also providing a degree of “fairness” between mobile terminals competing for transmission resources/slots.

When the next mobile terminal to be transmitted to is selected, the base station must choose an appropriate transport format. Multiple factors are taken into account when deciding on optimal transport format. One of these is the mobile terminal's reported quality indicator (CQI), which typically is calculated based on mobile terminal's perceived signal-to-noise ratio. Another factor is the mobile terminal's category/capabilities (for example whether it supports specific modulations like QAM64, or whether it can support various block sizes). Also the resources available in the downlink direction per mobile terminal are taken into account (which may be standard-dependent, and could include max. transmit power to mobile terminal, max, number of WCDMA codes or LTE slots).

In general, based on one or more of the factors mentioned above, the base station is trying to choose a transport format providing maximum throughput (i.e. largest block size) while guaranteeing high chances of successful reception. Typically 10-15% block error rate (KER.) is targeted.

In low-speed scenarios, it is relatively easy to choose an optimal transport format which will satisfy required BLER criteria, given CQI reported by the mobile terminal, because the signal-to-noise ratio of the mobile terminal changes relatively slowly, and is typically flat during the data block's reception time. The base station may choose from many possible combinations of parameters employing e.g. quadrature phase-shift keying (QPSK) or quadrature amplitude modulation (QAM16 or QAM64) with various coding rates, power settings, etc, when choosing a transport format. Multiple transport formats can be equivalent in terms of reception probability of the mobile terminal. That means that similarly sized data blocks (or transport blocks) can be encoded using various combinations of modulation parameters and can have very similar “receive quality” requirement by the mobile terminal. For example, the same 10000-bit data block may be encoded as QPSK with coding rate of 0.5 or as QAM16 with coding rate of 0.25, and the mobile terminal will have similar chance of receiving them successfully. That is because, while QAM16 has denser grid of data points, being more difficult to interpret at first, it also encodes twice as many bits, allowing for more redundancy information to be sent at the same time.

In high-speed scenarios however, problems occur when variation of signal-to-noise ratio within the reception time-slot of the block is very significant. At speeds above 30 km/h, there can be for example 10 dB signal-to-noise ratio difference at the receiver end between beginning and end of the data block (or transport block) reception. This is because of the very fast fading pattern, resulting in some bits being transmitted during “fading dip”. A consequence is that a certain percentage of received soft-bits (data fed into turbo decoder) will be practically destroyed and useless. If duration of the fading dip is a significant percentage of the receiving slot duration, then a large percentage of soft-bits will be damaged, and the block will not be decoded successfully.

### SUMMARY

Thus a transport format that is optimal for transmission of a given data block in a low speed scenario is not necessarily suitable for transmission of the same data block in a high speed scenario. In other words, a transport format scheduling algorithm that is able to select an optimal transport format in stationary or low speed scenarios will often not be able to select a suitable transport format in a high speed scenario.

Therefore, it is an object of embodiments of the disclosure to provide a method of selecting a transport format with improved performance in high speed conditions.

According to embodiments of the disclosure the object is achieved in a method in a device of selecting a transport format for transmission of data blocks between a base station and a mobile terminal in a wireless telecommunications, system, wherein the mobile terminal is capable of moving at a speed relative to the base station, the method comprising determining transport formats possible for transmission of data blocks from the device, each possible transport format having a defined code rate; and determining for each of said possible transport formats a set of quality metrics. The object is achieved when the method further comprises determining for each of said possible transport formats modified sets of quality metrics in dependence of speed and code rate for different speeds; estimating the speed of the mobile terminal relative to the base station, and selecting one of said possible transport formats for transmission of a data block in dependence of said estimated speed and said modified sets of quality metrics.

When modified quality metrics for each transport format are determined for different speeds and the selection of transport format is made from these modified quality metrics in dependence of the actual speed of the mobile terminal, a much better performance is achieved in high speed scenarios. A much better performance is achieved in high speed scenarios because the modified quality metrics indicate the performance for the transport formats with this speed.

In one embodiment the method further comprises storing said determined sets of quality metrics in a look-up table. The method may further comprise storing said modified sets of quality metrics in said look-up table.

The method may further comprise determining said modified sets of quality metrics by determining and storing speed dependent compensation factors for each of said possible transport formats.

In one embodiment the step of determining the modified sets of quality metrics is performed after the step of estimating the speed of the mobile terminal and by calculating a function in dependence of the estimated speed. In this embodiment the need for storing space in the device is reduced.

The determined set of quality metrics for each of said possible transport formats may comprise a transmission quality required to receive that transport format at the mobile terminal with a predefined block error rate.

Determining the sets of quality metrics and the modified sets of quality metrics may comprise performing simulations or measurements prior to selecting one of said possible transport formats.

In one embodiment, the step of selecting one of said possible transport formats comprises selecting a transport format having a code rate with a value that is low compared to the code rate of other ones of said possible transport formats. Transport formats with low code rates typically require less compensation for higher speeds, and thus they tend to be a more optimal selection in case of a high speed scenario.

Some embodiments of the disclosure also relate to a device configured to select a transport format for transmission of data blocks between a base station and a mobile terminal in a wireless telecommunications system, wherein the mobile terminal is capable of moving at a speed relative to the base station, the device having stored information of determined transport formats possible for transmission of data blocks from the device, each possible transport format having a defined code rate; and a set of quality metrics determined for each of said possible transport formats. The device is further configured to obtain modified sets of quality metrics determined for each of said possible transport formats in dependence of speed and code rate for different speeds; estimate the speed of the mobile terminal relative to the base station, and select of said possible transport formats for transmission of a data block in dependence of said estimated speed and said modified sets of quality metrics.

When modified quality metrics for each transport format can be determined for different speeds and the selection of transport format can be made from these modified quality metrics in dependence of the actual speed of the mobile terminal, a much better performance is achieved in high speed scenarios, because the modified quality metrics indicate the performance for the transport formats with this speed.

Embodiments corresponding to those mentioned above for the method also apply for the device.

In one embodiment, the device further comprises circuitry of a base station. Alternatively, the device may further comprise circuitry of a mobile terminal.

Some embodiments of the disclosure relate to a computer program and a computer readable medium with program code means for performing the method described above.

### BRIEF DESCRIPTION OF THE DRAWINGS

Embodiments of the disclosure will now be described more fully below with reference to the drawings, in which

FIG. 1 shows a block diagram of a device;

FIG. 2 shows a lookup table with potential transport formats and corresponding quality metrics determined for transmission to a stationary mobile terminal;

FIG. 3 shows a lookup table with potential transport formats and corresponding quality metrics determined for transmission to a mobile terminal moving with different speeds relative to the base station;

FIG. 4 shows a lookup table with potential transport formats and corresponding quality metrics determined for transmission to a stationary mobile terminal and compensation factors determined for transmission to a mobile terminal moving with different speeds relative to the base station;

FIG. 5 shows a flow chart of one embodiment of a method of selecting a transport format for transmission of data block to a mobile terminal;

FIG. 6 shows a flow chart of another embodiment of a method of selecting a transport format for transmission of data block to a mobile terminal; and

FIGS. 7a-7f show a comparison of two different transport formats at six different speeds illustrating that at high speeds, transport formats with a code rate containing high redundancy will give the best results.

### DETAILED DESCRIPTION

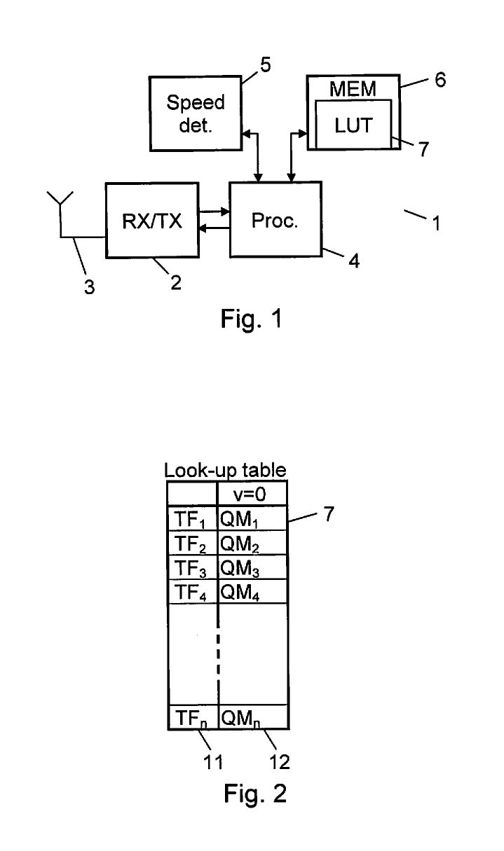

FIG. 1 shows a device (1), and in this example the device (1) is a base station in which one embodiment disclosed herein may be implemented. Receiver/transmitter circuitry (2) communicates via an antenna (3) with a number of mobile terminals or user equipments, while a data processing unit (4) (i.e. a processor, a programmable logic controller or similar) takes care of data processing, including selection of a transport format to be used for transmission of a data block from the base station to a mobile terminal. Connected to the processing unit (4) are also a speed detection unit (5) and a memory (6), i.e. a storage in which data bases, etc. may be stored. The speed detection unit (5) estimates the speed relative to the base station of a mobile terminal communicating with the base station. The speed of the mobile terminal may in one embodiment be estimated from the data signals received from the mobile terminal, and in another embodiment the speed may be estimated in the mobile terminal and the result is simply transmitted to the speed detection unit (5) in the base station (1) via a radio link between them.

The base station may also be referred to as an eNodeB or a NodeB or a radio access node or radio access element, etc. The mobile terminal may also be referred to as a user equipment or mobile station, etc.

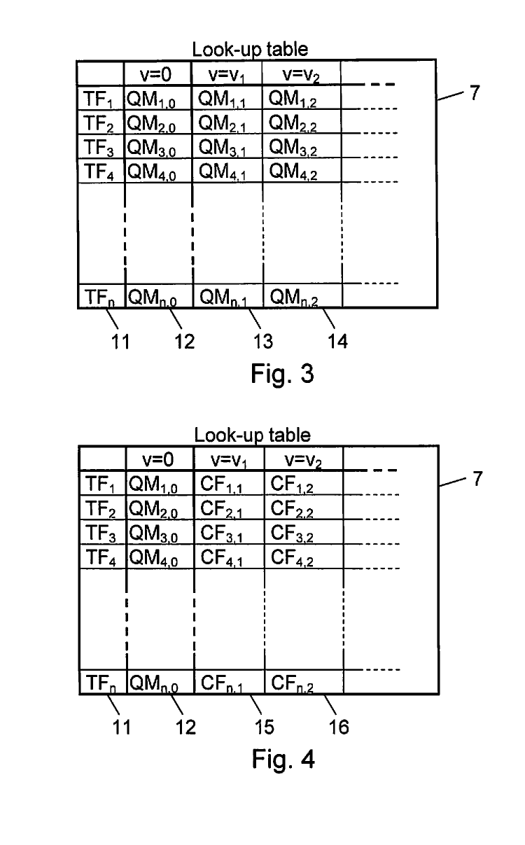

Thus selection of a transport format to be used for transmission of a data block from the base station to a mobile terminal is one of the tasks handled by the processing unit (4). When selecting a transport format for transmission of a data block, a prior art base station typically uses a large lookup table (7) stored in the memory (6) and containing all potential transport formats, TFs, together with additional information about each transport format, e.g. a quality metric, size of the data block etc. As an example, the quality metric can be a signal-to-noise ratio (SNR) or a signal-to-interference ratio (SIR) of the radio link between the base station and the mobile terminal required to receive the data at the mobile terminal with an acceptable block error rate (BLER), which is typically 10-30%. An example of such a lookup table (7) is illustrated in FIG. 2, in which all the possible transport formats (11) TF₁, TF₂, . . . , TFₙ are shown in one column together with their corresponding quality metrics (12) QM₁, QM₂, . . . ; QMₙ in the other column. The quality metrics (12) for the transport formats (11) may be derived from simulation or measurement, usually at 0 km/h. Typically, the simulations or measurements are performed in the design phase of the base station and then stored permanently in the memory (6), but the simulations or measurements may also take place in the base station during its use (i.e. during initial setup or during operation).

When selecting a transport format (11), the base station uses the quality metrics (12) stored in the lookup table (7). First, the base station is rejecting all transport formats which have too high SIR requirement and fail to satisfy other criteria. Out of the remaining suitable (or possible) transport formats (12) it may pick a transport format (12) with largest data block size.

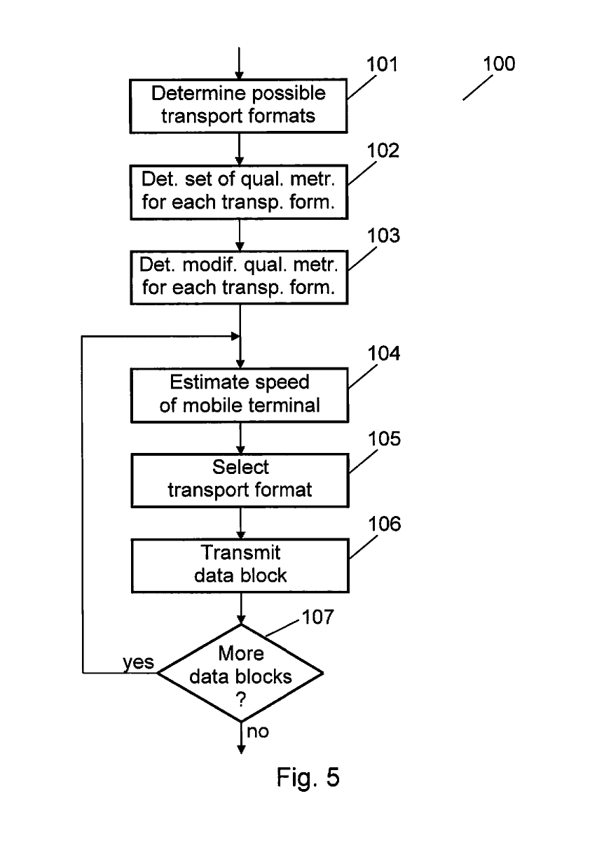

To improve the performance of selecting a transport format (11) in high speed situations the lookup table (7) may be extended to contain quality metrics (12, 13, 14, 15, 16) derived by simulation or measurements for different speeds or speed intervals in addition to the quality metrics derived for a stationary mobile terminal. A stationary mobile terminal is described herein with the meaning that is a mobile terminal that does not move in relation to a base station. This is illustrated in FIG. 3, where the quality metrics (12) QM_{1,0}, QM_{2,0}, . . . ; QM_{n,0} in column 12 correspond to the quality metrics (12) QM₁, QM₂, . . . ; QMₙ in FIG. 2, i.e. they are simulated or measured for a stationary mobile station, i.e, v=0, while column 13 shows quality metrics (13) QM_{1,1}, QM_{2,1}, . . . ; QM_{n,1} simulated or measured for a first speed v₁ and column 14 shows quality metrics (14) QM_{1,2}, QM_{2,2}, . . . ; QM_{n,2} simulated or measured for a second speed v₂, and so on.

The number of columns in the lookup table (7), i.e. the number of different speeds for the mobile terminal for which quality metrics (12, 13, 14) are calculated, may vary. Thus as an example, in a simple version there is just two columns, i.e. one for low speeds (speeds below a predetermined threshold), where the quality metrics calculated for a stationary mobile terminal are used, and another one for high speeds (speeds above the predetermined threshold), where the quality metrics calculated for a high speed are used. Another more complicated example could be a table with many columns with quality metrics calculated for several different speeds. This would provide a better selection of the transport format at the price of a higher demand for calculating resources and memory space.

Thus when a data block is to be transmitted to a mobile terminal the actual speed of the mobile terminal is determined by the speed detection unit (5), and the quality metrics (12, 13, 14) in the column of the lookup table (7) for the speed closest to the actual speed of the mobile terminal can then be used when selecting a transport format. Instead of using the speed in the lookup table (7) closest to the actual speed, interpolation or extrapolation may also be used. The selection of a transport format in itself, when using interpolation or extrapolation, is the same as described above. The difference is that the selection is based on quality metrics calculated for a speed close to the actual speed of the mobile terminal, which ensures an improved performance of selecting a transport format in high speed situations.

In the above, the selecting of a transport format is performed in a base station, where also the lookup table (7) is stored. However, the selection may also take place in a mobile terminal and the lookup table (7) can be stored in the mobile terminal. The selected transport format may be used for either uplink transmission or downlink transmission.

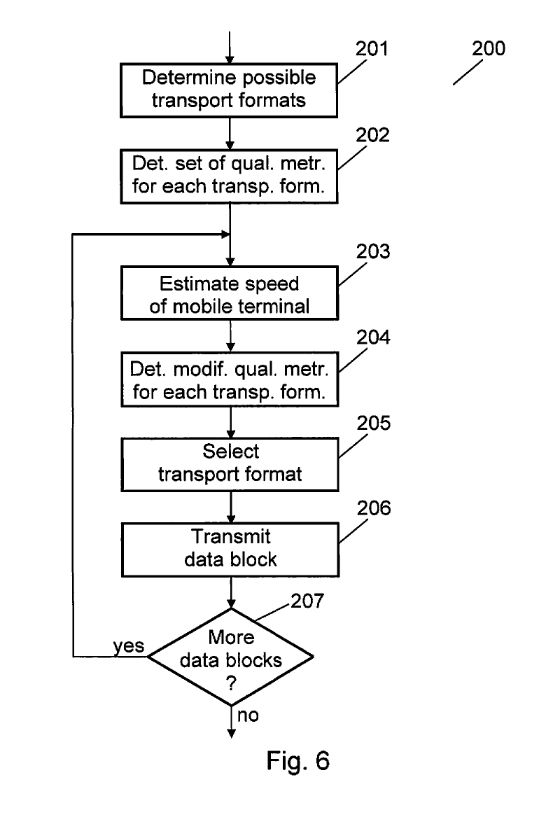

Instead of calculating and storing new or modified quality metrics for the different speeds in the lookup table (7), an alternative is to calculate and store compensation factors (15,16) for all transport formats (11) that may be used to modify the quality metrics calculated for v=0. This is illustrated in FIG. 4, where the compensation factors (15, 16) CF_{1,1}, CF_{2,1}, . . . ; CF_{n,1} and CF_{1,2}, CF_{2,2}, . . . ; CF_{n,2} for speeds v₁ and v₂, respectively, are shown in columns 15 and 16. Thus when the speed of a mobile terminal has been determined, the compensation factors (15, 16) of the corresponding column are used to modify the quality metrics (12) of column 12 before a transport format is selected based on the modified quality metrics. These compensation factors (15,16) will be speed-dependent. Some transport formats will suffer more degradation at high-speed and will require higher compensation, while other transport formats will require lower compensation.

The compensation factors (15,16) required for each transport format may be stored in lookup tables (7) as described above, or they may be approximated with some formulas or functions (depending on coding rate, speed etc).

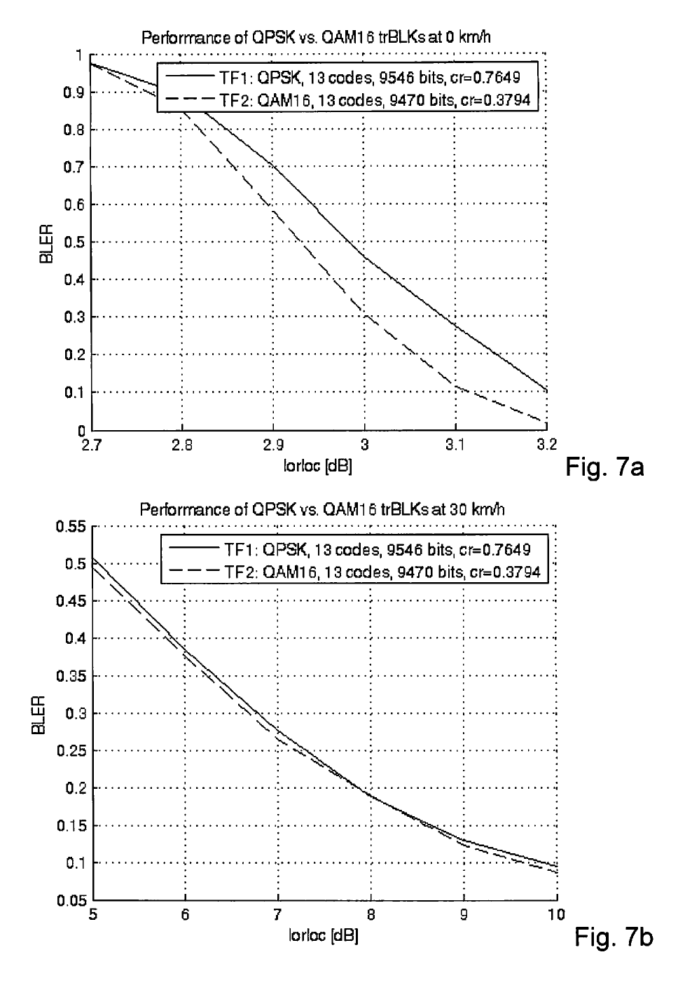

FIG. 5 shows a flowchart (100) illustrating one embodiment of the method of selecting a transport format (11). In step 101 all potential or possible transport formats (11) that can be used by the base station for transmission of data blocks to mobile terminals are determined. These transport formats include e.g. different block sizes, different modulation types and different code rates. In some embodiments the transport formats (11) are stored in column 11 of the lookup table (7). For each of these potential transport formats a quality metric (12) or a set of quality metrics (12) is determined in step 102, e.g. by simulation or measurement, for transmission to a stationary mobile terminal and e.g. stored in column 12 of the lookup table (7). These steps, 101 and/or 102, are typically performed in the design phase of the base station, and in that case the transport formats (11) and the corresponding quality metrics (12) are stored permanently in the memory (6) of the base station. However, the steps, 101 and/or 102 may also be performed in the base station during its use (i.e. during initial setup or during operation).

In step 103, modified quality metrics (13,14,15,16) or sets of modified quality metrics (13,14,15,16) are determined for each of these possible transport formats (11) by simulation or measurement for transmission to a mobile terminal moving with different speeds and stored in columns 13, 14, etc. of the lookup table (7). This step may be performed either in the design phase of the base station with the modified quality metrics being stored permanently in the memory (6), or it may be performed in the base station during its use, i.e. during operation or setup. In case of compensation factors (15,16) as shown in FIG. 4, these compensation factors may be performed in the design phase, while the modified quality metrics are then determined from these compensation factors when they are needed during use of the base station.

When a data block is to be transmitted from the base station to a mobile terminal, the actual (i.e. current) speed of the mobile terminal is determined by the speed detection unit (5) in step 104. As mentioned above, the speed can either be determined in the speed detection unit (5) from signals received from the mobile terminal, or the speed is determined in the mobile terminal and the result transmitted to the speed detection unit (5) in the base station,

When the speed of the mobile terminal is now known, the corresponding column of the lookup table (7), i.e. the column with quality metrics (13,14,15,16) determined for the speed closest to the actual speed of the mobile terminal, can be chosen, and the transport format (11) can be selected based on these quality metrics in step 105. This means that a transport format, for which the quality metric, e.g. the required signal-to-noise ratio to ensure reception of the data block at the mobile terminal with an acceptable block error rate, is sufficiently low, is selected. Thus the transport format is selected in dependence of the actual speed of the mobile terminal to which the data block is to be transmitted. Since each transport format has a defined code rate, the transport format is also selected in dependence of the code rate.

When the transport format (11) has been selected, the data block is transmitted to the mobile terminal in step 106. If there are more data blocks to be transmitted from the base station (step 107), steps 104 to 106 are repeated for the next data block. Otherwise, the process stops here.

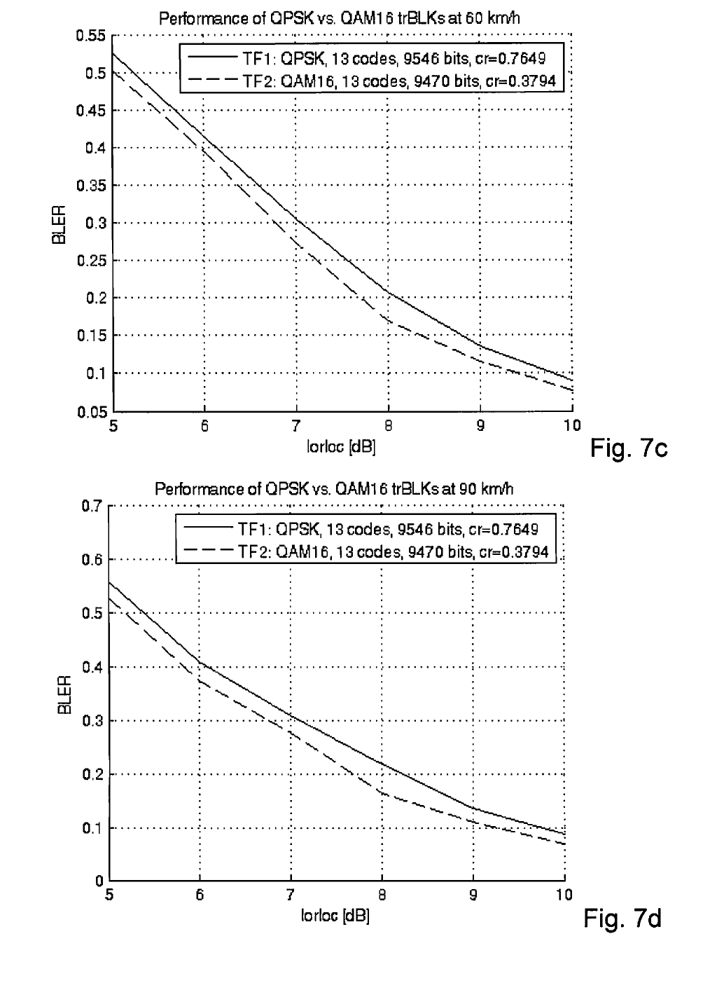

An alternative embodiment of the method of selecting a transport format (11) is illustrated in the flowchart 200 shown in FIG. 6. Steps 201 and 202 are the same as steps 101 and 102 in FIG. 5, and again these steps are typically performed in the design phase of the base station, while the following steps are performed in the base station during its operation.

When a data block is to be transmitted from the base station to a mobile terminal, the actual (i.e. current) speed of the mobile terminal is determined by the speed detection unit (5) in step 203. This is done in the same way as described above for step 104. Based on the determined speed modified quality metrics (13,14) or compensation factors (15,16) for each transport format (11) can then be determined for the determined speed in step 204. This can be done by formulas or functions stored in the device. The advantage of this solution, where the modified quality metrics or compensation factors are calculated dynamically, is that they need only by calculated for one speed, i.e. the determined actual speed of the mobile terminal relative to the base station. Based on these quality metrics or compensation factors the transport format can then be selected in step 205. This means that a transport format, for which the quality metric, e.g. the required signal-to-noise ratio to ensure reception of the data block at the mobile terminal with an acceptable block error rate, is sufficiently low, is selected. Thus the transport format (11) is selected in dependence of the actual speed of the mobile terminal to which the data block is to be transmitted.

When the transport format has been selected, the data block is transmitted to the mobile terminal in step 206. If there are more data blocks to be transmitted from the base station (step 207), steps 203 to 206 are repeated for the next data block. Otherwise, the process stops here.

As mentioned above, the transport format selected according to the described method is one for which the quality metric, e.g. the required signal-to-noise ratio to ensure reception of the data block at the mobile terminal with an acceptable block error rate, is sufficiently low. For high speeds this will typically be a transport format having a low code rate, because transport formats with lower code rates will generally require lower speed compensation factors. Therefore, after adjustment with the compensation factors in high-speed conditions, transport formats with lower code rates, having lower total quality requirements, would be selected more often. This will be described in further detail below.

The code rate is the proportion of a data-stream (e.g. a sequence of data blocks) that is useful (non-redundant). Thus, if the code rate is k/n, for every k bits of useful information, the coder generates totally n bits of data, of which n-k are redundant. For a given block size, the code rate is typically related to the modulation order. Higher order modulations allow for more bits of information to be communicated per modulation symbol, or they allow the same number of bits of information to be communicated with a lower code rate. In case of QPSK (quadrature phase-shift keying) modulation, the modulation alphabet consists of four different signalling alternatives, which allows for up to two bits of information to be communicated during each modulation symbol interval. In case of 16QAM (quadrature amplitude modulation), 16 different signalling alternatives are available, which allows for up to four bits of information to be communicated per symbol interval. In case of 64QAM (quadrature amplitude modulation), 64 different signalling alternatives allow for up to six bits of information to be communicated per symbol interval.

In low-speed scenarios, it is relatively easy to choose an optimal (or suitable) transport format, because the signal-to-noise ratio changes relatively slowly, and is typically flat during a data block's reception time. The base station may choose from many possible combinations of parameters employing different modulation schemes with various coding rates, power settings, etc. Multiple transport formats can be equivalent in terms of reception probability of the mobile terminal. That means that similarly sized transport blocks (data blocks) can be encoded using various combinations of modulation parameters (e.g. modulation type, code rate, etc.) and can have very similar “receive quality” requirement by the mobile terminal. For example, the same 10000-bit data block may be encoded as QPSK with coding rate of 0.5 or as QAM16 with coding rate of 0.25, and the mobile terminal will have similar chance of receiving them successfully. That is because, while QAM16 has denser grid of data points, being more difficult to interpret at first, it also encodes twice as many bits, allowing for more redundancy information to be sent at the same time.

In high-speed scenarios the variation of signal-to-noise ratio within the reception time-slot of a data block is very significant. At speeds above 30 km/h, there can be for example 10 dB signal-to-noise ratio difference at the receiver end between beginning and end of the transport block reception. This is because of the very fast fading pattern, resulting in some bits being transmitted during “fading dip”. The serious consequence is that a certain percentage of received soft-bits (data fed into turbo decoder) will be practically destroyed and useless. If duration of the fading dip is a significant percentage of the receiving slot duration, then a large percentage of soft-bits will be damaged, and the block will not be decoded successfully.

The pattern of the impairment (damage) to received soft-bits is different at high speeds compared to slow speeds. At slow speeds, all soft-bits have similar SNR, while at high speeds, some soft-bits may be extremely good while others are completely destroyed. Whether a frame with partially destroyed soft-bits will be decoded successfully, depends on the percentage of frame damage, and on robustness of the coding scheme (the amount of redundancy present in the sequence). For example, if fading dip destroyed 30% of soft-bits (with 70% bits having good quality), but coding rate was 0.33 (meaning that for each information bit, 2 extra parity bits were generated and transmitted), then the decoder should easily regenerate the whole transmitted block. However, if the coding rate was 0.8, then the frame would fail the CRC check.

Thus at high speeds, transport formats with a code rate containing highest possible redundancy, i.e. the lowest code rate, will give the best results. For example, instead of QPSK with a code rate of 0.75, base station should choose QAM16 with a code rate of 0.375 or even equivalent QAM64 with a code rate of 0.25 (if the mobile terminal supports QAM64). It is possible to employ transport formats with coding rate below 0.33 by way of using repetition coding. Using very high-order modulations, in uncertain high-speed conditions, may seem counter-intuitive, however it provides best results.

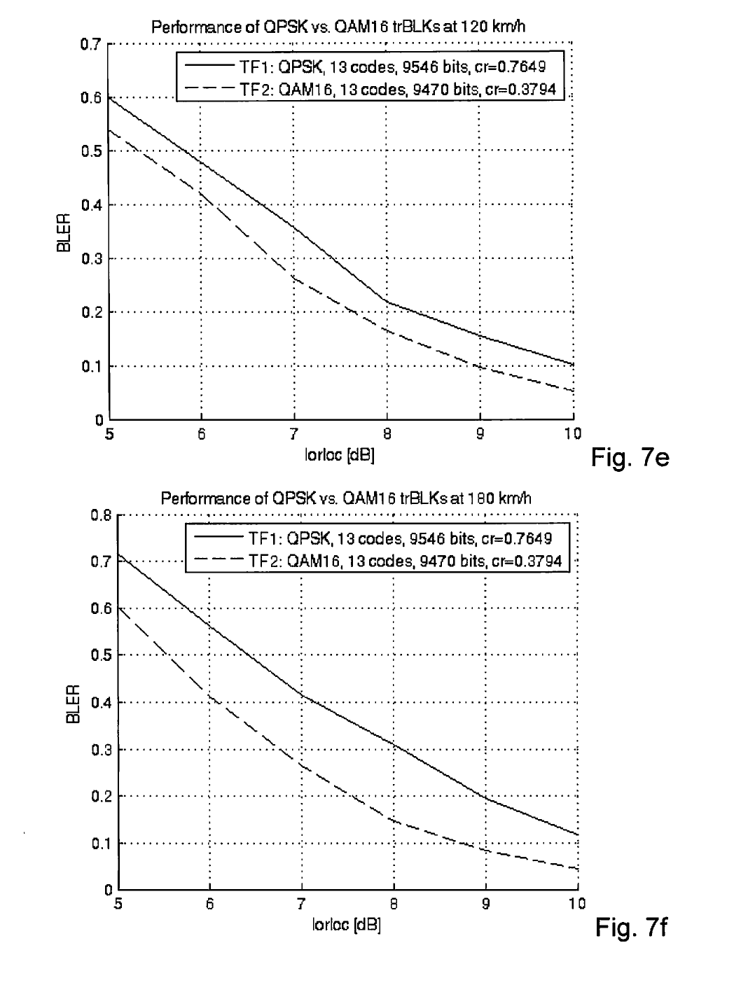

This is illustrated in the graphs shown in FIGS. 7a-7f, which show a comparison of two different transport formats at six different speeds, i.e. 0, 30, 60, 90, 120 and 180 km/h. It is noted that the scales of the graph for 0 km/h (FIG. 7a) are different from the scales used on the other graphs. The graphs show the, resulting BLER for a given signal-to-noise ratio (lorloc equals SNR) for the two transport formats. The two transport formats TF1 and TF2 are QPSK code rate 0.76 (TF1) and QAM64 code rate 0.379 (TF2)

FIG. 7a shows that at 0 km/h, their performance is very similar (approx 0.1 dB difference), 0.1 dB is very little, they have practically same performance. Performance difference is the distance between plots, measured ALONG X axis (lorloc=SNR), taken at the level of the desired BLER level (V axis). Desired BLER level is usually 10-30% (i.e. 0.1-0.3 on Y axis).

It can be seen that performance difference between them grows with speed. It is approx:

0.1 dB at 30 km/h (same as AWGN)

0.2-0.4 dB at 60 km/h

0.3-0.6 dB at 90 km/h

0.7-1 dB at 120 km/h

1.2-1.4 dB at 180 km/h

That means that at 0 km/h, the two transport formats are similar, while at high speed they become radically different. In all cases the transport format with the lower code rate gives better results, because a lower signal-to-noise ratio (i.e. quality metric) is required to obtain a given block error rate.

Therefore, when the lookup tables (7) as described above are adjusted properly with compensation factors for different speeds, the base station would then choose more optimal transport format at a given speed.

The graphs in FIGS. 7a-7f are obtained by simulations. Another simulation showing the same is described below. In order to demonstrate potential gains from the method, VA 120 km/h simulation has been setup (utilizing LAMP WCDMA simulator). Two very similar transport formats have been created, one with QAM16 and the other with QPSK:

TF1; QPSK, 13 codes, Transport Block (bits)=9546, coding rate=0.7649

TF2: QAM16, 13 codes, Transport Block (bits)=9470, coding rate=0.3794

The sizes of data blocks (transport block) have been chosen in such a way to have identical performance in AWGN tests (i.e. identical receive quality “RxQual” requirement). Then VA-120 simulations have been performed at various lorloc levels to establish relative performance of the two blocks:

| lorloc | | | | |
|---|---|---|---|---|
| [dB] | TF1 BLER [%] | TF1 TPUT | TF2 BLER [%] | TF2 TPUT |
| 10 | 29.4 | 3363 | 21.5 | 3708 |
| 11 | 20.8 | 3776 | 12.2 | 4155 |
| 12 | 12.0 | 4199 | 6.1 | 4445 |
| 13 | 7.1 | 4430 | 3.7 | 4555 |

Clearly TF2 has better VA120 performance than TF1. The advantage is equivalent to approx. 1 dB in lorloc. More gain could be seen with QAM64 and even more aggressive coding.

The idea described above could be applicable to any telecommunication standard supporting high-speeds (e.g. LTE, Wimax, WCDMA etc).

In the above, selecting a transport format (11) is performed in a base station. However, the selection of a transport format (11) may also take place in a mobile terminal, and the selected transport format may be used for either uplink transmission or downlink transmission.

Although various embodiments of the present disclosure have been described and shown, it is not restricted thereto, but may also be embodied in other ways within the scope of the subject-matter defined in the following claims.

1-19. (canceled)

20. A method in a device of selecting a transport format for transmission of data blocks between a base station and a mobile terminal in a wireless telecommunications system, wherein the mobile terminal is capable of moving at a speed relative to the base station, the method comprising:
determining transport formats possible for transmission of data blocks from the device, each possible transport format having a defined code rate; and
determining for each of said possible transport formats a set of quality metrics;
wherein the method further comprises:
determining for each of said possible transport formats modified sets of quality metrics in dependence of speed and code rate for different speeds;
estimating the speed of the mobile terminal relative to the base station, and
selecting one of said possible transport formats for transmission of a data block in dependence of said estimated speed and said modified sets of quality metrics,

21. A method according to claim 20, wherein the method further comprises storing said determined sets of quality metrics in a look-up table,

22. A method according to claim 21, wherein the method further comprises storing said modified sets of quality metrics in said look-up table.

23. A method according to claim 20, wherein the method further comprises determining said modified sets of quality metrics by determining and storing speed dependent compensation factors for each of said possible transport formats.

24. A method according to claim 20, *herein the step of determining the modified sets of quality metrics is performed after the step of estimating the speed of the mobile terminal and by calculating a function in dependence of the estimated speed.

25. A method according to claim 20, wherein the determined set of quality metrics for each of said possible transport formats comprises a transmission quality required to receive that transport format at the mobile terminal with a predefined block error rate.

26. A method according to claim 20, wherein determining the sets of quality metrics and the modified sets of quality metrics comprises performing simulations or measurements prior to selecting one of said possible transport formats.

27. A method according to claim 20, wherein the step of selecting one of said possible transport formats comprises selecting a transport format having a code rate with a value that is low compared to the code rate of other ones of said possible transport formats.

28. A device configured to select a transport format for transmission of data blocks between a base station and a mobile terminal in a wireless telecommunications system, wherein the mobile terminal is capable of moving at a speed relative to the base station, the device having stored information of:
determined transport formats possible for transmission of data blocks from the device, each possible transport format having a defined code rate; and
a set of quality metrics determined for each of said possible transport formats;
wherein the device comprises:
a speed detection unit configured to estimate the speed of the mobile terminal relative to the base station, and
a processing unit configured to
obtain modified sets of quality metrics determined for each of said possible transport formats in dependence of speed and code rate for different speeds; and
select one of said possible transport formats for transmission of a data block in dependence of said estimated speed and said modified sets of quality metrics.

29. A device according to claim 28, wherein said determined sets of quality metrics are stored in a look-up table.

30. A device according to claim 29, wherein said modified sets of quality metrics are stored in said look-up table.

31. A device according to claim 28, wherein the device has stored the information of the modified sets of quality metrics as speed dependent compensation factors determined for each of said possible transport formats.

32. A device according to claim 28, wherein the device is configured to obtain the modified sets of quality metrics by calculating a function in dependence of the estimated speed of the mobile terminal.

33. A device according to claim 28, wherein the determined set of quality metrics for each of said possible transport formats comprises a transmission quality required to receive that transport format at the mobile terminal with a predefined block error rate.

34. A device according to claim 28, wherein the device is configured to select one of said possible transport formats by selecting a transport format having a code rate with a value that is low compared to the code rate of other ones of said possible transport formats.

35. A device according to claim 28, characterized in that the device further comprises circuitry of a base station.

36. A device according to claim 28, characterized in that the device further comprises circuitry of a mobile terminal.

37. A computer program comprising program code means for performing the steps of claim 20 when said computer program is run on a computer.

38. A computer readable medium having stored thereon program code means for performing the method of claim 20 when said program code means is run on a computer.
